(19) United States
(12) Patent Application Publication
(10) Pub. No.: US 2021/0041731 A1
(43) Pub. Date: Feb. 11, 2021

(54) ARRAY SUBSTRATE AND LIQUID CRYSTAL DISPLAY PANEL

(71) Applicant: TCL China Star Optoelectronics Technology Co., Ltd., Shenzhen, Guangdong (CN)

(72) Inventor: Lixuan CHEN, Shenzhen, Guangdong (CN)

(21) Appl. No.: 16/616,482

(22) PCT Filed: Sep. 17, 2019
(86) PCT No.: PCT/CN2019/106178

§ 371 Date: Nov. 24, 2019

(30) Foreign Application Priority Data
Aug. 8, 2019 (CN) 201910730955.5

(51) Int. Cl. G02F 1/1362; G02F 1/1333

(52) U.S. Cl. CPC G02F 1/1362; G02F 2001/136222; G02F 1/133345

(57) ABSTRACT

An array substrate, and a liquid crystal display panel are provided. The array substrate includes a glass substrate, a first passivation layer, a color filter layer, a second passivation layer, a first transparent conductive layer, and a first polymer insulating layer. The first passivation layer is disposed on the glass substrate. The color filter layer is disposed on the first passivation layer. The second passivation layer is disposed on the color filter layer. The first transparent conductive layer is disposed on the second passivation layer. The first polymer insulating layer is covering the first transparent conductive layer. The first passivation layer includes an organic material.

### FIELD

The present disclosure relates to display technologies, and more particularly, to an array substrate, and a liquid crystal display panel.

### BACKGROUND

Skin color deviation is an important design specification for liquid crystal display (LCD) TVs. It is generally defined by the difference in chromaticity brightness between the front view (0°) and the oblique view (30 to 60°) of the picture showing the human skin color. It is prescribed that the chromaticity (x, y) deviation when viewed from an oblique angle and a front view must be within a certain range. However, a Vertical Alignment (VA) LCD sometimes cannot meet this color deviation specification.

Among the VA LCDs with the color deviation problems, the products with color filter on array (COA) design are more serious than non-COA products. This phenomenon has led to greater difficulties and limitations in the design of COA products. Therefore, there is a need to solve the above issues.

### SUMMARY

In view of the above, the present disclosure provides an array substrate, and a liquid crystal display panel to resolve technical issues that the products with COA design are more serious than non-COA products.

In order to achieve above-mentioned object of the present disclosure, one embodiment of the disclosure provides an array substrate includes a glass substrate, a first passivation layer, a color filter layer, a second passivation layer, a first transparent conductive layer, and a first polymer insulating layer. The first passivation layer is disposed on the glass substrate. The color filter layer is disposed on the first passivation layer. The second passivation layer is disposed on the color filter layer. The first transparent conductive layer is disposed on the second passivation layer. The first polymer insulating layer is covering the first transparent conductive layer. The first passivation layer includes a material including an organic material.

In one embodiment of the array substrate of the disclosure, the second passivation layer includes a material including an organic material.

In one embodiment of the array substrate of the disclosure, a thickness of the second passivation layer is less than 1.5 μm and a material refractive index of the second passivation layer is less than 1.8.

In one embodiment of the array substrate of the disclosure, a thickness of the first passivation layer is less than 1.5 μm and a material refractive index of the first passivation layer is less than 1.8.

Furthermore, another embodiment of the disclosure provides an array substrate including a glass substrate, a first passivation layer, a first interlayer, a color filter layer, a second passivation layer, a first transparent conductive layer, and a first polymer insulating layer. The first passivation layer is disposed on the glass substrate. The first interlayer is disposed on the first passivation layer. The color filter layer is disposed on the first interlayer. The second passivation layer is disposed on the color filter layer. The first transparent conductive layer is disposed on the second passivation layer. The first polymer insulating layer is covering the first transparent conductive layer. The first passivation layer includes silicon nitride. A material refractive index of the first interlayer ranges from 1.6 to 1.8. A thickness of the first interlayer is less than 1 μm.

Furthermore, another embodiment of the disclosure provides a liquid crystal display panel including a glass substrate, a first passivation layer, a first interlayer, a color filter layer, a second passivation layer, a first transparent conductive layer, a first polymer insulating layer, a liquid crystal layer, a second polymer insulating layer, a second transparent conductive layer, and a glass cover. The first passivation layer is disposed on the glass substrate. The first interlayer is disposed on the first passivation layer. The color filter layer is disposed on the first interlayer. The second passivation layer is disposed on the color filter layer. The first transparent conductive layer is disposed on the second passivation layer. The first polymer insulating layer is covering the first transparent conductive layer. The liquid crystal layer is disposed on the first polymer insulating layer. The second polymer insulating layer is disposed on the liquid crystal layer. The second transparent conductive layer is disposed on the second polymer insulating layer. The glass cover is disposed on the second transparent conductive layer. The first passivation layer includes silicon nitride. A material refractive index of the first interlayer ranges from 1.6 to 1.8. A thickness of the first interlayer is less than 1 μm.

In one embodiment of the disclosure, the liquid crystal display panel further including a second interlayer disposed between the color filter layer and the second passivation layer. The second passivation layer includes silicon nitride. A material refractive index of the second interlayer ranges from 1.6 to 1.8. A thickness of the second interlayer is less than 1 μm.

In one embodiment of the liquid crystal display panel of the disclosure, the material refractive index of the second interlayer ranges from 1.6 to 1.7, and the thickness of the second interlayer is less than 300 nm.

In one embodiment of the liquid crystal display panel of the disclosure, the material refractive index of the first interlayer ranges from 1.6 to 1.7, and a thickness of the first interlayer is less than 300 nm.

In comparison with prior art, the array substrate and the liquid crystal display panel of the disclosure provides the first interlayer under the color filter layer, or a second interlayer above the color filter layer. The first passivation layer or the second passivation layer includes an organic material to reduce a difference refractive index between the first or the second passivation layer and the color filter layer. Transmittance difference of various color is reduced by reducing loss of interface reflection. Differences in brightness between each color when viewing oblique angles are reduced. Degree of color deviation at different viewing angles is reduced and display quality of the screen is improved.

### BRIEF DESCRIPTION OF DRAWINGS

FIG. 1 is a schematic view of a structure of a liquid crystal display panel according to an embodiment of the present disclosure.

FIG. 2 is a schematic view of a structure of a liquid crystal display panel according to another embodiment of the present disclosure.

### DETAILED DESCRIPTION

The following description of the embodiments is provided by reference to the drawings and illustrates the specific embodiments of the present disclosure. Directional terms mentioned in the present disclosure, such as “up,” “down,” “top,” “bottom,” “forward,” “backward,” “left,” “right,” “inside,” “outside,” “side,” “peripheral,” “central,” “horizontal,” “peripheral,” “vertical,” “longitudinal,” “axial,” “radial,” “uppermost” or “lowermost,” etc., are merely indicated the direction of the drawings. Therefore, the directional terms are used for illustrating and understanding of the application rather than limiting thereof.

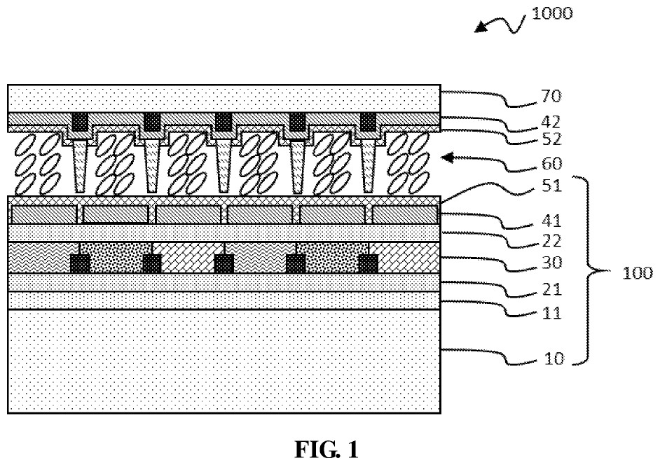

Referring to FIG. 1, one embodiment of the disclosure provides an array substrate 100 includes a glass substrate 10, a first passivation layer 21, a color filter layer 30, a second passivation layer 22, a first transparent conductive layer 41, and a first polymer insulating layer 51. The first passivation layer 21 is disposed on the glass substrate 10. The color filter layer 30 is disposed on the first passivation layer 21. The second passivation layer 22 is disposed on the color filter layer 30. The first transparent conductive layer 41 is disposed on the second passivation layer 22. The first polymer insulating layer 51 is covering the first transparent conductive layer 41. The first passivation layer 21 includes an organic material.

In one embodiment of the array substrate of the disclosure, the second passivation layer 22 includes an organic material.

In one embodiment of the array substrate of the disclosure, a thickness of the second passivation layer 22 is less than 1.5 μm and a material refractive index of the second passivation layer 22 is less than 1.8.

In one embodiment of the array substrate of the disclosure, a thickness of the first passivation layer 21 is less than 1.5 μm and a material refractive index of the first passivation layer 21 is less than 1.8.

In detail, the liquid crystal display panel 1000 includes the array substrate 100, a liquid crystal layer 60, a second polymer insulating layer 52, a second transparent conductive layer 42, and a glass cover 70.

In detail, the liquid crystal display panel 1000 further includes a gate insulating layer 11 disposed between the first passivation layer 21 and the glass substrate 10.

In detail, the refractive index abovementioned refers to real values of the refractive index when 480 nm light is incident on the material.

In detail, the color filter layer 30 includes a plurality of filter blocks with different color. For example, the color filter layer 30 includes a red filter block, a green filter block, and a blue color filter. The disclosure is not limit to this.

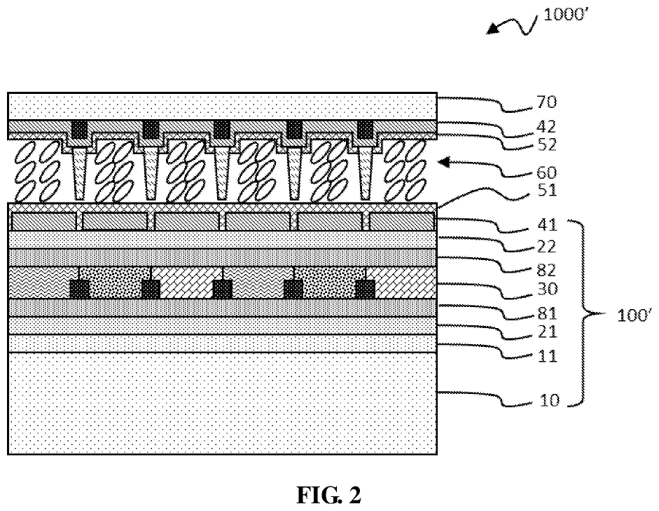

Furthermore, referring to FIG. 2, another embodiment of the disclosure provides an array substrate 100′ including a glass substrate 10, a first passivation layer 21, a first interlayer 81, a color filter layer 30, a second passivation layer 22, a first transparent conductive layer 41, and a first polymer insulating layer 51. The first passivation layer 21 is disposed on the glass substrate 10. The first interlayer 81 is disposed on the first passivation layer 21. The color filter layer 30 is disposed on the first interlayer 81. The second passivation layer 22 is disposed on the color filter layer 30. The first transparent conductive layer 41 is disposed on the second passivation layer 22. The first polymer insulating layer 51 is covering the first transparent conductive layer 41. The first passivation layer 21 includes silicon nitride. A material refractive index of the first interlayer 81 ranges from 1.6 to 1.8. A thickness of the first interlayer 81 is less than 1 μm.

In one embodiment of the disclosure, the array substrate 100′ further including a second interlayer 82 disposed between the color filter layer 30 and the second passivation layer 22. The second passivation layer 22 includes silicon nitride. A material refractive index of the second interlayer 82 ranges from 1.6 to 1.8. A thickness of the second interlayer 82 is less than 1 μm.

In one embodiment of the disclosure, the material refractive index of the second interlayer 82 ranges from 1.6 to 1.7, and the thickness of the second interlayer 82 is less than 300 nm.

In one embodiment of the disclosure, the material refractive index of the first interlayer 81 ranges from 1.6 to 1.7, and a thickness of the first interlayer 81 is less than 300 nm to further reduce interface reflection.

Furthermore, referring to FIG. 2, another embodiment of the disclosure provides a liquid crystal display panel 1000′ including a glass substrate 10, a first passivation layer 21, a first interlayer 81, a color filter layer 30, a second passivation layer 22, a first transparent conductive layer 41, a first polymer insulating layer 51, a liquid crystal layer 60, a second polymer insulating layer 52, a second transparent conductive layer 42, and a glass cover 70. The first passivation layer 21 is disposed on the glass substrate 10. The first interlayer 81 is disposed on the first passivation layer 21. The color filter layer 30 is disposed on the first interlayer 81. The second passivation layer 22 is disposed on the color filter layer 30. The first transparent conductive layer 41 is disposed on the second passivation layer 22. The first polymer insulating layer 51 is covering the first transparent conductive layer 41. The liquid crystal layer 60 is disposed on the first polymer insulating layer 51. The second polymer insulating layer 52 is disposed on the liquid crystal layer 60. The second transparent conductive layer 42 is disposed on the second polymer insulating layer 52. The glass cover 70 is disposed on the second transparent conductive layer 42. The first passivation layer 21 includes silicon nitride. A material refractive index of the first interlayer 81 ranges from 1.6 to 1.8. A thickness of the first interlayer 81 is less than 1 μm.

In detail, the liquid crystal display panel 1000′ further includes a gate insulating layer 11 disposed between the first passivation layer 21 and the glass substrate 10.

In detail, the refractive index abovementioned refers to real values of the refractive index when 480 nm light is incident on the material.

In detail, the color filter layer 30 includes a plurality of filter blocks with different color. For example, the color filter layer 30 includes a red filter block, a green filter block, and a blue color filter. The disclosure is not limit to this.

In comparison with prior art, the array substrate and the liquid crystal display panel of the disclosure provides the first interlayer under the color filter layer, or a second interlayer above the color filter layer. The first passivation layer or the second passivation layer includes an organic material to reduce a difference refractive index between the first or the second passivation layer and the color filter layer. Transmittance difference of various color is reduced by reducing loss of interface reflection. Differences in brightness between each color when viewing oblique angles are reduced. Degree of color deviation at different viewing angles is reduced and display quality of the screen is improved.

The present disclosure has been described by the above embodiments, but the embodiments are merely examples for implementing the present disclosure. It must be noted that the embodiments do not limit the scope of the invention. In contrast, modifications and equivalent arrangements are intended to be included within the scope of the invention.

What is claimed is:

1. An array substrate, comprising:
a glass substrate;
a first passivation layer disposed on the glass substrate;
a color filter layer disposed on the first passivation layer;
a second passivation layer disposed on the color filter layer;
a first transparent conductive layer disposed on the second passivation layer; and
a first polymer insulating layer covering the first transparent conductive layer, wherein the first passivation layer comprises an organic material.

2. The array substrate according to claim 1, wherein the second passivation layer comprises an organic material.

3. The array substrate according to claim 2, wherein a thickness of the second passivation layer is less than 1.5 μm and a material refractive index of the second passivation layer is less than 1.8.

4. The array substrate according to claim 1, wherein a thickness of the first passivation layer is less than 1.5 μm and a material refractive index of the first passivation layer is less than 1.8.

5. An array substrate, comprising:
a glass substrate;
a first passivation layer disposed on the glass substrate;
a first interlayer disposed on the first passivation layer;
a color filter layer disposed on the first interlayer;
a second passivation layer disposed on the color filter layer;
a first transparent conductive layer disposed on the second passivation layer; and
a first polymer insulating layer covering the first transparent conductive layer, wherein the first passivation layer comprises silicon nitride, a material refractive index of the first interlayer ranges from 1.6 to 1.8, and a thickness of the first interlayer is less than 1 μm.

6. The array substrate according to claim 5, further comprising a second interlayer disposed between the color filter layer and the second passivation layer, wherein the second passivation layer comprises silicon nitride, a material refractive index of the second interlayer ranges from 1.6 to 1.8, and a thickness of the second interlayer is less than 1 μm.

7. The array substrate according to claim 6, wherein the material refractive index of the second interlayer ranges from 1.6 to 1.7, and the thickness of the second interlayer is less than 300 nm.

8. The array substrate according to claim 6, wherein the material refractive index of the first interlayer ranges from 1.6 to 1.7, and the thickness of the first interlayer is less than 300 nm.

9. The array substrate according to claim 5, wherein the material refractive index of the first interlayer ranges from 1.6 to 1.7, and the thickness of the first interlayer is less than 300 nm.

10. A liquid crystal display panel, comprising:
a glass substrate;
a first passivation layer disposed on the glass substrate;
a first interlayer disposed on the first passivation layer;
a color filter layer disposed on the first interlayer;
a second passivation layer disposed on the color filter layer;
a first transparent conductive layer disposed on the second passivation layer;
a first polymer insulating layer covering the first transparent conductive layer;
a liquid crystal layer disposed on the first polymer insulating layer;
a second polymer insulating layer disposed on the liquid crystal layer;
a second transparent conductive layer disposed on the second polymer insulating layer; and
a glass cover disposed on the second transparent conductive layer, wherein the first passivation layer comprises silicon nitride, a material refractive index of the first interlayer ranges from 1.6 to 1.8, and a thickness of the first interlayer is less than 1 μm.

11. The liquid crystal display panel according to claim 10, further comprising a second interlayer disposed between the color filter layer and the second passivation layer, wherein the second passivation layer comprises silicon nitride, a material refractive index of the second interlayer ranges from 1.6 to 1.8, and a thickness of the second interlayer is less than 1 μm.

12. The liquid crystal display panel according to claim 11, wherein the material refractive index of the second interlayer ranges from 1.6 to 1.7, and the thickness of the second interlayer is less than 300 nm.

13. The liquid crystal display panel according to claim 12, wherein the material refractive index of the first interlayer ranges from 1.6 to 1.7, and a thickness of the first interlayer is less than 300 nm.

14. The liquid crystal display panel according to claim 11, wherein the material refractive index of the first interlayer ranges from 1.6 to 1.7, and the thickness of the first interlayer is less than 300 nm.

15. The liquid crystal display panel according to claim 10, wherein the material refractive index of the first interlayer ranges from 1.6 to 1.7, and the thickness of the first interlayer is less than 300 nm.
